(19) United States
(12) Patent Application Publication
(10) Pub. No.: US 2018/0116439 A1
(43) Pub. Date: May 3, 2018

(54) PORTABLE BUFFET SYSTEM AND METHOD

(71) Applicant: Theresa Sanzone, Rio Rancho, NM (US)

(72) Inventor: Theresa Sanzone, Rio Rancho, NM (US)

(21) Appl. No.: 15/789,932

(22) Filed: Oct. 20, 2017

Related U.S. Application Data
(60) Provisional application No. 62/416,113, filed on Nov. 1, 2016.

(51) Int. Cl. A47J 27/12; A23L 5/10; A47J 27/00; A47J 37/06; A47J 36/16

(52) U.S. Cl. CPC A47J 27/12; A23L 5/10; A23V 2002/00; A47J 37/06; A47J 36/16; A47J 27/004

(57) ABSTRACT

A transportable cooking system includes a transportable cabinet, a cooking surface, and a power source. The cooking surface may have a plurality of heating elements placed evenly on an outer top planar surface of the transportable cabinet. The transportable cooking system is useful for heating cooking pans with comestibles therein; and a power source may be configured to supply sufficient electrical current to the plurality of heating elements as needed. The transportable cooking system may be designed as a self-contained, powered, remotely useable means for cooking the comestibles and storing cooking-related-items. The transportable cabinet is mobile such that it can be moved between locations for cooking and storing with relative ease using wheeled castors.

### CROSS-REFERENCE TO RELATED APPLICATION(S)

The present application is related to and claims priority to U.S. Provisional Patent Application No. 62/416,113 filed Nov. 1, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of cooking appliances in the existing art and more specifically relates to portable heated food preparation means.

### RELATED ART

Many food items are best prepared on a stovetop; however, it is not always possible or convenient to cook on a conventional stove. Gas and electric stoves only work with those sources of heat, and are rarely easily moved from one place to another. Many guesthouses and dormitories do not allow stoves, which can make options limited for residents. In addition, many people enjoy cooking on their patio, but would prefer an option other than a barbeque grill. Typically, when cooking for guests, a host has their back to the group while preparing food on a traditional barbeque grill. This can make it difficult for guests to have conversations and interact with the host.

Cooking is the art, technology and craft of preparing food for consumption with the use of heat. Cooking techniques and ingredients vary widely across the world, from grilling food over an open fire, to using electric stoves, to baking in various types of ovens, reflecting unique environmental, economic and cultural traditions, and trends. It is therefore desirable to be able to cook at any preferred location.

U.S. Pub. No. 2007/0119442 to Wei-Teh Ho relates to a portable cooking device. The described portable cooking device includes a cooking platform and a set of cooking tools. The cooking platform has two symmetrically disposed cooking chambers; a heating tube is disposed in each chamber. Two pivotal elements are provided between the two chambers and two handles are provided on a top surface of the device. Whence, several cooking tools may be chosen from so as to be placed on either cooking chamber, and food may be placed on a cooking tool so as to be cooked by the heating tube. After cooking is finished, the two pivotal elements allow the cooking device to be folded and carried around.

### SUMMARY OF THE INVENTION

In view of the foregoing disadvantages inherent in the known portable heated food preparation art, the present disclosure provides a novel portable buffet system and method. The general purpose of the present disclosure, which will be described subsequently in greater detail, is to provide a portable buffet system and method.

A transportable cooking system is disclosed herein. The transportable cooking system includes a transportable cabinet, a cooking surface, and a power source. The cooking surface may have a plurality of heating elements placed evenly on an outer top planar surface of the transportable cabinet. The plurality of heating elements is configured to heat cooking pans with comestibles therein; and a power source may be configured to supply sufficient electrical current to the plurality of heating elements as needed. The transportable cooking system may be designed as a self-contained, powered, remotely useable means for cooking the comestibles and storing cooking-related-items. The transportable cabinet is mobile such that it can be moved between locations for cooking and storing with relative ease using wheeled castors.

The transportable cabinet may house a drip tray under the plurality of heating elements so that comestible debris may be caught while cooking. Internal shelving may be provided to house cooking-related-items for use when needed. A pull-out grill may be housed under the drip tray for use when grilling may be necessary. The transportable cabinet may include a rechargeable power source with a USB connection which may allow power access for mobile devices that use USB power and a power strip designed to provide power when needed to the external electrical outlets on the outer top planar surface.

The transportable cabinet may include a cover for the plurality of heating elements, which may provide protection from the elements. When in use, the cover for the plurality of heating elements may convert to a tray to hold items needed while cooking. Control knobs may be provided for the plurality of heating elements so that the amount of electrical current may be varied for heating different types of comestibles. An outer-surface of the transportable cabinet may be treated to protect the transportable cabinet from inclement weather. Further, the transportable cabinet may be constructed from ferrous material, and alternately, non-ferrous or other suitable material.

According to another embodiment, a method of using a transportable cooking system is also disclosed herein. The method of using a transportable cooking system includes providing the device disclosed, moving a transportable cooking system to a desired location, lifting a cover exposing a plurality of heating elements, using the cover to support items needed while cooking, preparing comestibles for consumption on the plurality of heating elements, using internal shelving to store cooking-related-items, pulling a pull-out grill to expose the grilling surface for use, controlling the plurality of heating elements with a control knob, charging a transportable cooking system for use when power is not readily available, charging a USB device using a USB connection provided on the transportable cooking system, and using external electrical outlets to power devices as needed for preparing comestibles.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a portable buffet system and method, constructed and operative according to the teachings of the present disclosure.

FIG. 1 is a perspective view of the transportable cooking system during an ‘in-use’ condition, according to an embodiment of the disclosure.

FIG. 2 is a perspective view of the transportable cooking system of FIG. 1, according to an embodiment of the present disclosure.

FIG. 3 is a perspective view of the transportable cooking system of FIG. 1, according to an embodiment of the present disclosure.

FIG. 4 is a perspective view of the transportable cooking system of FIG. 1, according to an embodiment of the present disclosure.

FIG. 5 is a flow diagram illustrating a method of using a transportable cooking system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a portable heated food preparation and more particularly to a transportable cooking system as used to provide the capability of cooking comestibles from any location.

Generally, in certain areas, guest houses do not come equipped with stoves. In addition, some people may want to cook outside, but do not want the hassle of using a barbeque grill. The system can also be used on an apartment patio. This can add convenience to outdoor cooking, and can lessen smoke, and would be less of a disturbance to neighbors. The system can come in various sizes, and can have removable elements for easy cleaning and replacement. The system can be made out of different materials such as metal, wood, compressed wood and other suitable materials. The wheels can have locks on them so that the system does not move when it is in use. The ideal form of the system would be a cabinet that can be any size to fit storage area or cooking devices with a top cooking surface, flat surface or hot plate with external power pack that can be charged by outlet or solar and storage underneath for needed items; further, the entire system is easily stored when not in use.

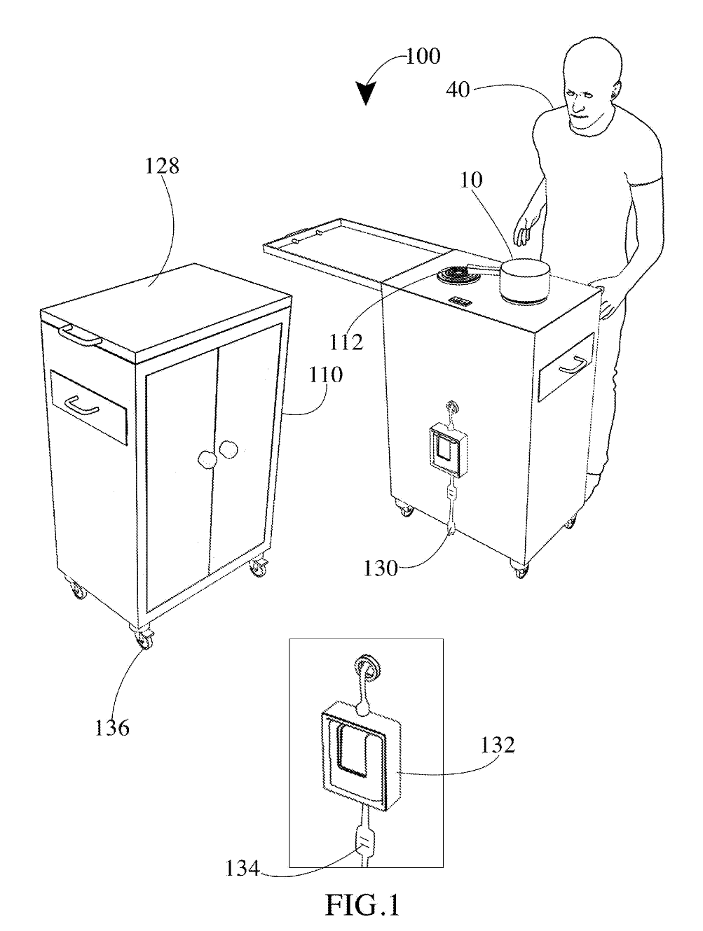

Referring now more specifically to the drawings by numerals of reference, there is shown in FIGS. 1-4, various views of a transportable cooking system 100.

FIG. 1 shows a transportable cooking system 100 during an ‘in-use’ condition 50, according to an embodiment of the present disclosure. Here, the transportable cooking system 100 may be beneficial for use by a user 40 to cook comestibles from any location. As illustrated, the transportable cooking system 100 may include a transportable cabinet 110, a cooking surface 120, and a power source 130. A rechargeable power source 132 with a USB connection 134 may be used for charging a USB device of the user 40. A cover 128 may be used to protect an outer top planar surface 114, and alternately, the cover 128 may be used to support items needed while cooking. Wheeled castors 136 may be used to move the transportable cabinet 110 between locations for cooking and storing with relative ease.

According to one embodiment, the transportable cooking system 100 may be arranged as a kit 105. In particular, the transportable cooking system 100 may further include a set of instructions 107. The instructions 107 may detail functional relationships in relation to the structure of the transportable cooking system 100 such that the transportable cooking system 100 can be used, maintained, or the like, in a preferred manner.

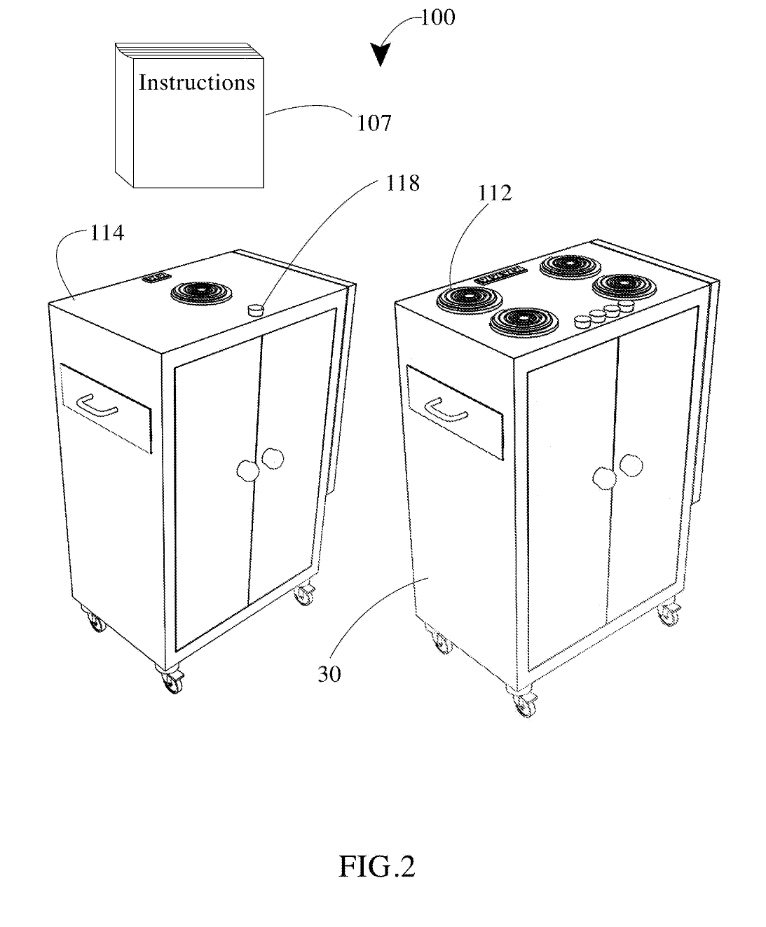

FIG. 2 shows the transportable cooking system 100 of FIG. 1, according to an embodiment of the present disclosure. As above, the transportable cooking system 100 may include a transportable cabinet 110, a cooking surface 120, and a power source 130. The transportable cabinet 110 may include a cooking surface 120 having a plurality of heating elements 112 placed evenly on an outer top planar surface 114 of the transportable cabinet 110 which may be configured to heat cooking pans 10 with comestibles therein. The transportable cabinet 110 may be constructed from ferrous material 30, and alternately, non-ferrous material 50.

The cooking surface 120 may include a plurality of heating elements 112, external electrical outlets 116 on an outer top planar surface 114 and control knobs 118 for adjusting an amount of electrical current. This may be useful for cooking comestibles at different temperatures so that the comestibles may be cooked properly. The transportable cooking system 100 may be designed as a self-contained, powered, remotely useable means for cooking comestibles and storing cooking-related-items 15.

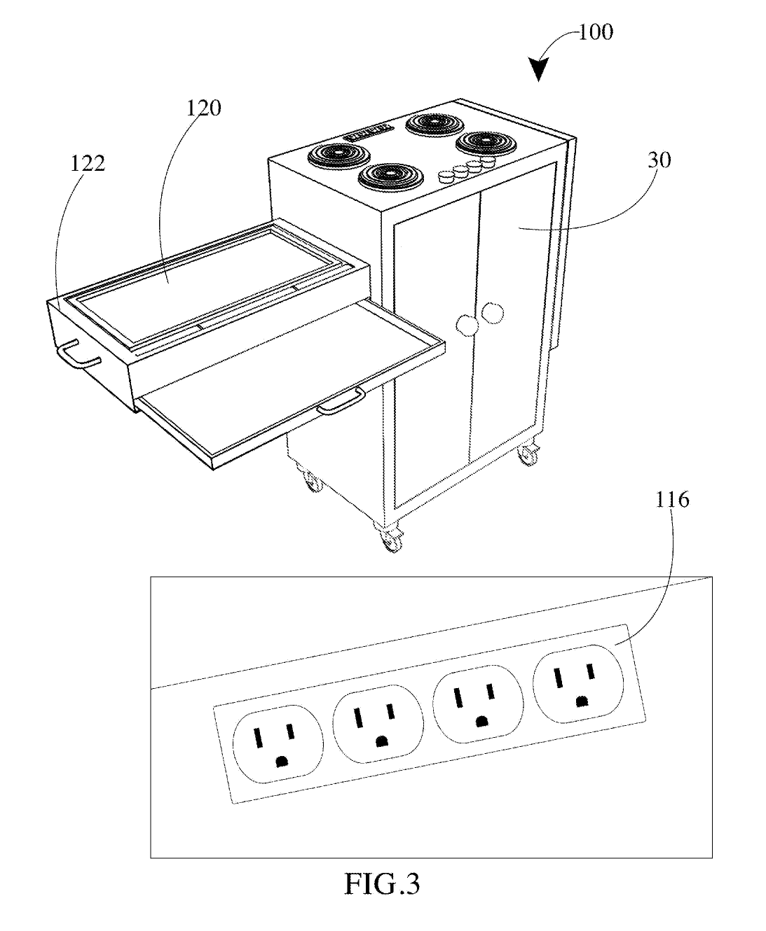

FIG. 3 is a perspective view of the transportable cooking system 100 of FIG. 1, according to an embodiment of the present disclosure. The transportable cabinet 110 may house a pull-out grill 122 under a drip-tray 124, also disposed under a plurality of heating elements 112. External electrical outlets 116 may be used to power devices as needed for preparing various comestibles.

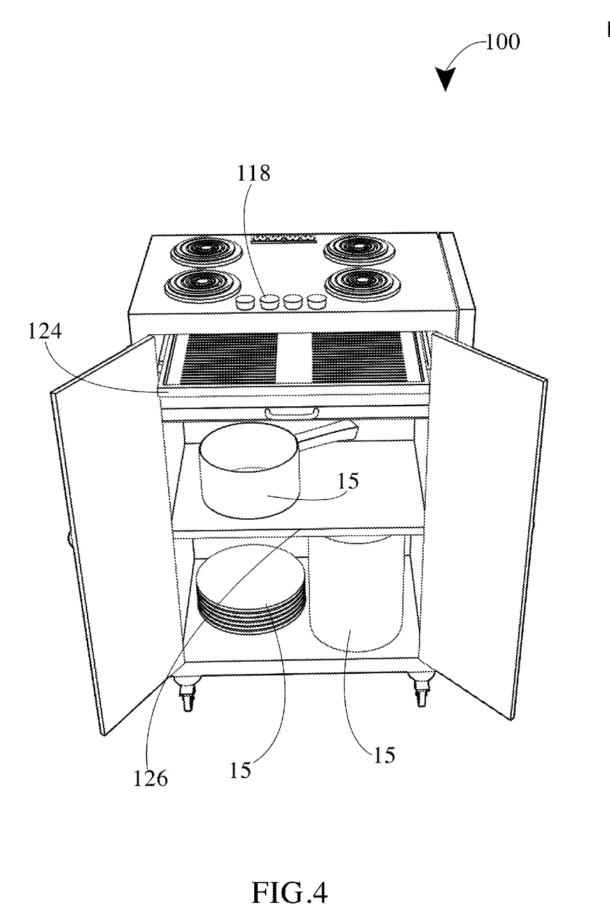

FIG. 4 is a perspective view of the transportable cooking system 100 of FIG. 1, according to an embodiment of the present disclosure. Internal shelving 126 may house cooking-related-items 15 under a drip-tray 124 beneath an outer top planar surface 114. A plurality of heating elements 112, external electrical outlets 116 and control knobs 118 may also be present for adjusting an amount of electrical current to the plurality of heating elements 112.

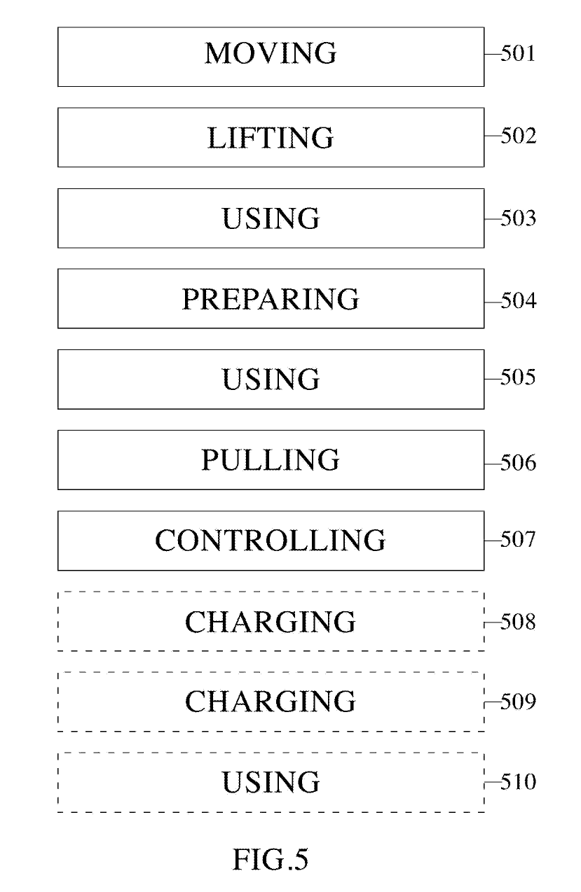

FIG. 5 is a flow diagram illustrating a method for using 500 a transportable cooking system 100, according to an embodiment of the present disclosure. In particular, the method for using 500 a transportable cooking system 100 may include one or more components or features of the using a transportable cooking system 100 as described above. As illustrated, the method for using 500 a transportable cooking system 100 may include the steps of providing the present invention and then: step one 501, moving a transportable cooking system to a desired location; step two 502, lifting a cover 128 exposing a plurality of heating elements 112; step three 503, using the cover 128 to support items needed while cooking; step four 504, preparing comestibles for consumption on the plurality of heating elements 112; step five 505, using internal shelving 126 to store cooking-related-items 15; step six 506, pulling a pull-out grill 122 to expose the grilling surface for use; step seven 507, controlling the plurality of heating elements 112 with a control knob 118; step eight 508, charging a transportable cooking system 100 for use when power is not readily available; step nine 509, charging a USB device using a USB connection 134 provided on the transportable cooking system 100; and step ten 510, using external electrical outlets 116 to power devices as needed for preparing comestibles.

It should be noted that steps 508-510 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for using a transportable cooking system 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A transportable cooking system, the system comprising:
a transportable cabinet including;
a cooking surface having a plurality of heating elements, the plurality of heating elements placed evenly on an outer top planar surface of the transportable cabinet, wherein the plurality of heating elements is configured to heat cooking pans with comestibles therein; and
a power source configured to supply sufficient electrical current to the plurality of heating elements as needed; and
wherein the transportable cabinet is structured and arranged to provide a plurality of said heating elements that are supplied with power from the power source which is housed within the transportable cabinet, the plurality of heating elements located on the outer top planar surface; and
wherein said transportable cooking system is designed as a self-contained, powered, remotely useable means for cooking said comestibles and storing cooking-related-items.

2. The system of claim 1, wherein the transportable cabinet houses a drip tray under the plurality of heating elements.

3. The system of claim 1, wherein the transportable cabinet comprises and provides internal shelving.

4. The system of claim 2, wherein the transportable cabinet houses a pull-out grill under the drip tray.

5. The system of claim 1, wherein the transportable cabinet includes a rechargeable power source.

6. The system of claim 1, wherein the transportable cabinet includes wheeled castors.

7. The system of claim 1, wherein the transportable cabinet includes a cover for the plurality of heating elements.

8. The system of claim 7, wherein the cover for the plurality of heating elements converts to a tray.

9. The system of claim 1, wherein the transportable cabinet comprises a power strip designed to provide power.

10. The system of claim 1, wherein the transportable cabinet includes external electrical outlets on the outer top planar surface.

11. The system of claim 1, wherein the transportable cabinet includes control knobs for the plurality of heating elements.

12. The system of claim 1, wherein a rechargeable power source includes a USB connection.

13. The system of claim 1, wherein an outer-surface of the transportable cabinet is treated to protect the transportable cabinet from inclement weather.

14. The system of claim 1, wherein the transportable cabinet is constructed from ferrous material.

15. The system of claim 1, wherein the transportable cabinet is constructed from non-ferrous material.

16. The system of claim 1, wherein the transportable cabinet is mobile such that it can be moved between locations for cooking and storing with relative ease.

17. A transportable cooking system, the system comprising:
a transportable cabinet;
wherein the transportable cabinet houses a drip tray under a plurality of heating elements, a pull-out grill under the drip tray, internal shelving, a rechargeable power source with a USB connection, a power strip designed to provide power with external electrical outlets on the outer top planar surface, and wheeled castors so that the transportable cabinet can be moved between locations for cooking and storing with relative ease;
a cooking surface having a plurality of heating elements, the plurality of heating elements placed evenly on an outer top planar surface of the transportable cabinet, wherein the plurality of heating elements is configured to heat cooking pans with comestibles therein;
a power source configured to supply sufficient electrical current to the plurality of heating elements as needed and control knobs for adjusting an amount of electrical current;
wherein the transportable cabinet is structured and arranged to provide a plurality of said heating elements that are supplied with power from the power source which is housed within the transportable cabinet, the plurality of heating elements located on the outer top planar surface;
wherein a cover is provided for the plurality of heating elements and the cover converts to a tray for holding cooking-related-items when in use;
wherein the transportable cabinet is constructed from ferrous material, and alternately, non-ferrous material;
wherein an outer-surface of the transportable cabinet is treated to protect the transportable cabinet from inclement weather; and
wherein said transportable cooking system is designed as a self-contained, powered, remotely useable means for cooking said comestibles and storing cooking-related-items.

18. The system of claim 17, further comprising set of instructions; and
wherein the system is arranged as a kit.

19. A method of using a transportable cooking system, the method comprising the steps of:
providing the transportable cooking system;
moving the transportable cooking system to a desired location;
lifting a cover exposing a plurality of heating elements;
using the cover to support items needed while cooking;
preparing comestibles for consumption on the plurality of heating elements;
using internal shelving to store cooking-related-items;
pulling a pull-out grill to expose the grilling surface for use; and
controlling the plurality of heating elements with a control knob.

20. The method of claim 19, further comprising the steps of:
charging a transportable cooking system for use when power is not readily available;
charging a USB device using a USB connection provided on the transportable cooking system; and
using external electrical outlets to power devices as needed for preparing comestibles.
